(19) United States
(12) Patent Application Publication
(10) Pub. No.: US 2015/0198452 A1
(43) Pub. Date: Jul. 16, 2015

(54) DRIVING DIRECTION BASED ON WEATHER FORECASTING SYSTEM AND METHOD

(71) Applicants: Raghav Gupta, Cupertino, CA (US); Haoran Guan, Sunnyvale, CA (US); Prachi Agarwal, Mountain View, CA (US)

(72) Inventors: Raghav Gupta, Cupertino, CA (US); Haoran Guan, Sunnyvale, CA (US); Prachi Agarwal, Mountain View, CA (US)

(21) Appl. No.: 14/519,011

(22) Filed: Oct. 20, 2014

Related U.S. Application Data
(60) Provisional application No. 61/867,614, filed on Aug. 20, 2013.

(51) Int. Cl. G01C 21/34

(52) U.S. Cl. CPC G01C 21/3407

(57) ABSTRACT

Navigation based on a weather forecasting system and method. A weather-based system and method for navigating or routing from an initial destination to a final destination. Routing may involve driving, air travel or the like. The system receives via a mobile computing device, a starting and destination location information and uses recent sequence of periodic real-time weather data for the starting, destination and in-between areas information to determine expected weather movement for the near future for respective areas. Based, in part, on the expected weather movement for the near future, the system determines optimal routing directions from the start to final destination.

### CLAIM OF PRIORITY

The present non-provisional application claims priority from U.S. Provisional Application No. 61/867,614, filed Aug. 20, 2013, entitled Driving Directions Based on Weather Forecasting System and Method, which is hereby incorporated in its entirety as if fully set forth in the present application.

### CROSS-REFERENCE TO RELATED APPLICATIONS

The present application is related to the following co-pending applications, each of which is hereby incorporated by reference in its entirety: U.S. application Ser. No. ______ titled “VIRTUAL METEOROLOGIST BASED ON WEATHER FORECASTING SYSTEM” filed on Oct. 20, 2014; and U.S. application Ser. No. ______ titled “WEATHER FORECASTING SYSTEM” filed on Oct. 20, 2014.

### BACKGROUND OF THE INVENTION

The present invention relates generally to communication and computer systems and methods and more specifically to communication and computer systems and methods for facilitating driving directions based on weather forecasting.

Severe weather such as lightning strikes, heavy snow, hurricanes and the like, can cause catastrophic property damage. Hundreds of thousands weather-related fatalities also occur each year.

Although many users have access to the local weather forecasting service, such as those that are provided by the radio and television news, injuries and fatalities still result every year. Many users are unable to adapt conventional weather forecasting systems to meet their particular needs. Navigation systems that provide driving directions from one location to another have also become important. Many users employ such navigation systems to travel from one location to another; such trips, however, may be severely hampered by inclement weather.

It is within the aforementioned context that a need for the present invention has arisen. Thus, there is a need to address one or more of the foregoing disadvantages of conventional systems and methods, and the present invention meets this need.

### BRIEF SUMMARY OF THE INVENTION

Various aspects of driving directions based on weather forecasting system and method can be found in exemplary embodiments of the present invention.

In a first embodiment, the driving directions based on weather forecasting system and method can calculate the predicted motion of snow, rain storms, clouds, lightning strikes, hurricanes and other similar weather type patterns and display them on a real-time basis and on high definition graphics.

The system then uses this predicted weather data to provide optimal driving directions to users wishing to travel from one location to another. As used herein, driving directions include not only automobile driving directions, but also encompasses aircraft directions, cycling and running, motorcycling directions, waterway directions and any other type of directions involving transportation from one location to another based on severe weather conditions.

In another embodiment, a weather-based method for navigating from one location to another is disclosed. The method uses a mobile computing device (or other computing device types) in communication with a server having a processor. The method receives via the mobile computing device, a starting location on a map and a destination location from which an in-between area is determined.

Recent weather data is collected for respective locations, where the recent weather data includes data for a recent time interval before the starting time of a trip. The recent weather data is then used to determine expected weather movement, which in part is employed to determine an optimal route from the starting location through or around the in-between area to the destination.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates a weather forecasting system according to an exemplary embodiment of the present invention.

FIG. 2A illustrates a predictive server system (real-time and adaptable) with journey planning engine according to an exemplary embodiment of the present invention.

FIG. 2B illustrates a forecasting algorithm method according to an exemplary embodiment of the present invention.

FIG. 2C illustrates a driving direction interface screenshot of the weather application of FIG. 1 according to an exemplary embodiment of the present invention.

FIG. 2D illustrates a driving directions interface screenshot of FIG. 2C showing navigation directions from “1 Sansome Street, San Francisco, Calif.” to “228 Hamilton Avenue in Palo Alto, Calif.”.

FIG. 2E illustrates a navigation and routing method according to an exemplary embodiment of the present invention.

FIG. 3 illustrates computer architecture for use with an exemplary embodiment of the present invention.

FIG. 4 illustrates a screenshot of map and weather data superimposed according to exemplary embodiments of the present invention.

FIG. 5 illustrates a screenshot of maps superimposed with weather data according to exemplary embodiments of the present invention.

FIG. 6 illustrates a screenshot of maps superimposed with weather data according to exemplary embodiments of the present invention.

FIG. 7 illustrates a screenshot of maps superimposed with weather data according to exemplary embodiments of the present invention.

FIG. 8 illustrates a screenshot of maps superimposed with weather data according to exemplary embodiments of the present invention.

FIG. 9 illustrates a screenshot of maps superimposed with weather data according to exemplary embodiments of the present invention.

FIG. 10 illustrates a screenshot of maps superimposed with weather data according to exemplary embodiments of the present invention.

FIG. 11 illustrates a screenshot of maps superimposed with weather data according to exemplary embodiments of the present invention.

FIG. 12 illustrates a registration interface according to an exemplary embodiment of the present invention.

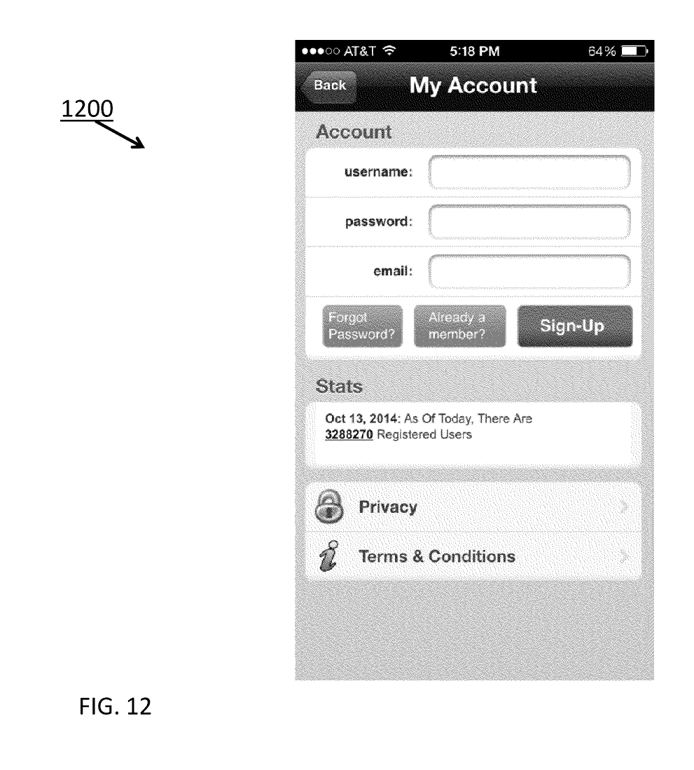

FIG. 13A illustrates user customization for use with the present invention, according to one embodiment.

FIG. 13B illustrates user customization for use with the present invention, according to one embodiment.

FIG. 13C illustrates user customization for use with the present invention, according to one embodiment.

FIG. 14A illustrates exemplary location selection interfaces for use with the present invention, according to one embodiment.

FIG. 14B illustrates exemplary location selection interfaces for use with the present invention, according to one embodiment.

FIG. 14C illustrates exemplary location selection interfaces for use with the present invention, according to one embodiment.

FIG. 15 illustrates exemplary interfaces including indications of lightning strikes, according to an exemplary embodiment of the present invention.

FIG. 16 illustrates exemplary interfaces including indications of lightning strikes, according to an exemplary embodiment of the present invention.

FIG. 17 illustrates a weather interface, according to an exemplary embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

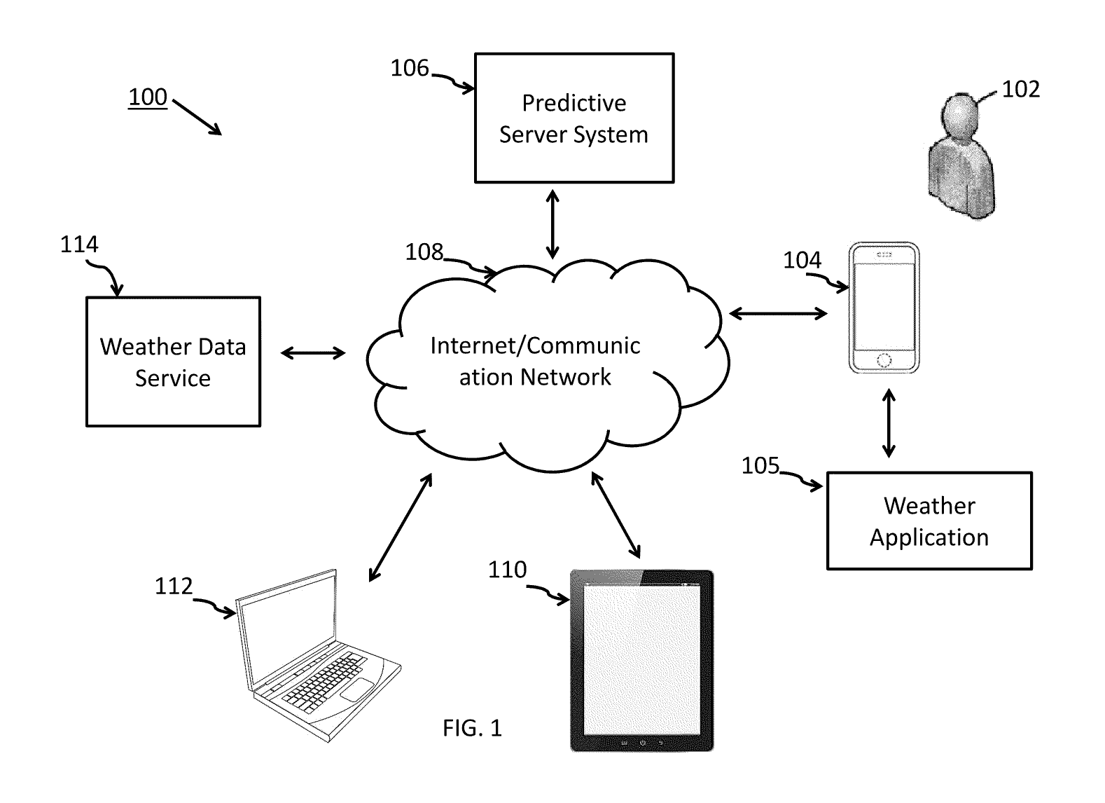

FIG. 1 illustrates weather forecasting system 100 according to an exemplary embodiment of the present invention.

In FIG. 1, weather forecasting system 100 is real-time and can be adapted or customized by users for their particular needs. Weather forecasting system 100 can calculate the predicted motion of rain storms, clouds, lightning strikes, hurricanes and other similar weather type patterns and display them on a real-time basis and on high definition graphics. Users may also select their locations, receive push notifications and alerts and otherwise adapt weather predictions for their own individual needs.

Here, weather forecasting system 100 includes user 102 communicably coupled to predictive server system 106 via Internet/communication network 108. Specifically, user 102 can use mobile computing device 104 to communicate with predictive server system 106. Mobile computing device 104 might be a mobile communication device such as an iPhone™ or the like.

In FIG. 1, user 102 may also utilize another communication device namely device 110 to access the predictive server system 106 via Internet/communication network 108. User 102 may further employ desktop 112 for access to the predictive server system 106. In turn, predictive server system 106 is itself communicably coupled to weather Data Service 114 via Internet/communication network 108. Although not shown, weather data service 114 can be any service that provides weather data, water, and climate data, forecasts and associated warnings.

To initiate use, user 102 employs mobile computing device 104 by registering to receive access predictive server system 106. Upon registration, user 102 then uses mobile computing device 104 to download and launch weather application 105. Not only can weather application 105 be downloaded onto a mobile device such as mobile computing device 104, it can be downloaded to any processor-capable device such as a desktop computer, a wireless device, an iPad, iPhone, etc. Weather application 105 also referred to as Radar Cast™ might be available at Apple's™ App. Store or at www.weathersphere.com.

Once weather application 105 is launched, user 102 can use weather application 105 to interact with predictive server system 106 to provide dynamic past/present/future display of weather patterns on a real time basis as further described below. As noted, weather application 105, in conjunction with predictive server system 106, can calculate the predicted motion of rain storms, clouds, lightning strikes, hurricanes and other similar weather type patterns and display them on a real time basis and on stunning graphics displayed in sequence on mobile computing device 104.

As noted above, not only can weather application 105 be downloaded onto a mobile device such as mobile computing device 104, it can be downloaded to any processor-capable device such as a desktop computer, a wireless device, an iPad, iPhone, etc. Directions can also be provided via electronic mail, SMS and the like. Other such communication media within the spirit and scope of the present invention may also receive directions based on the present invention. Additional novel features and further illustration will be described with reference to the figures below.

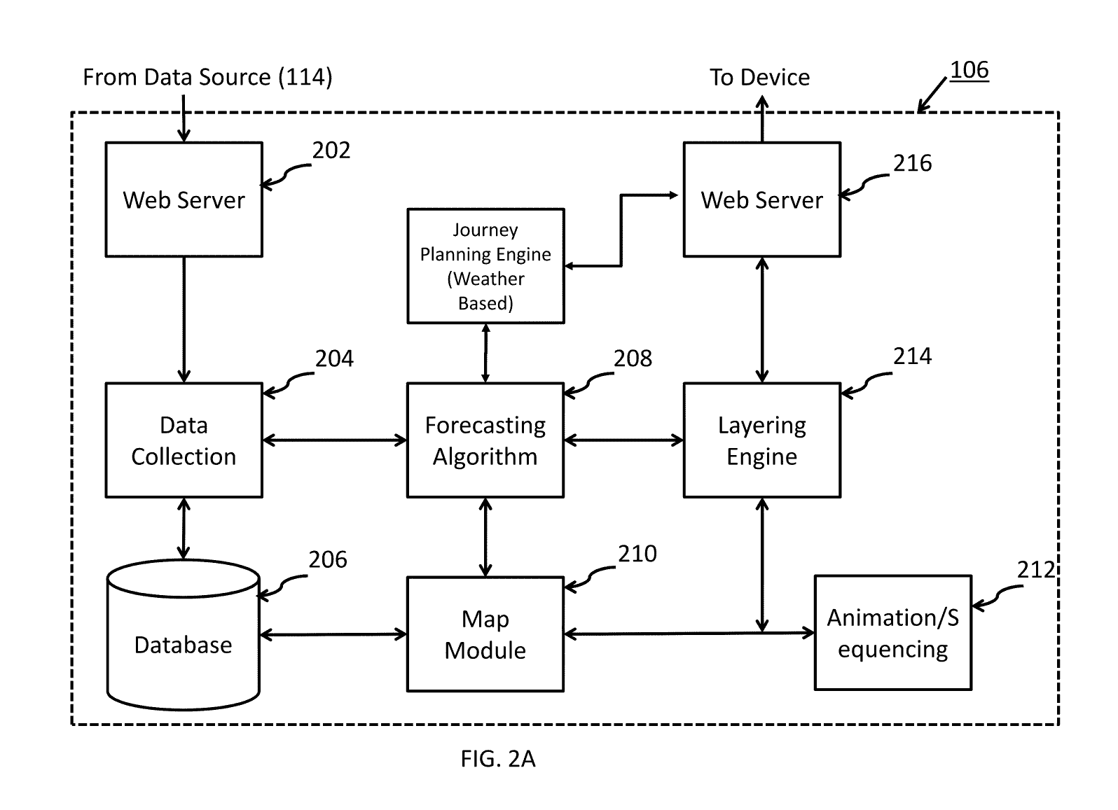

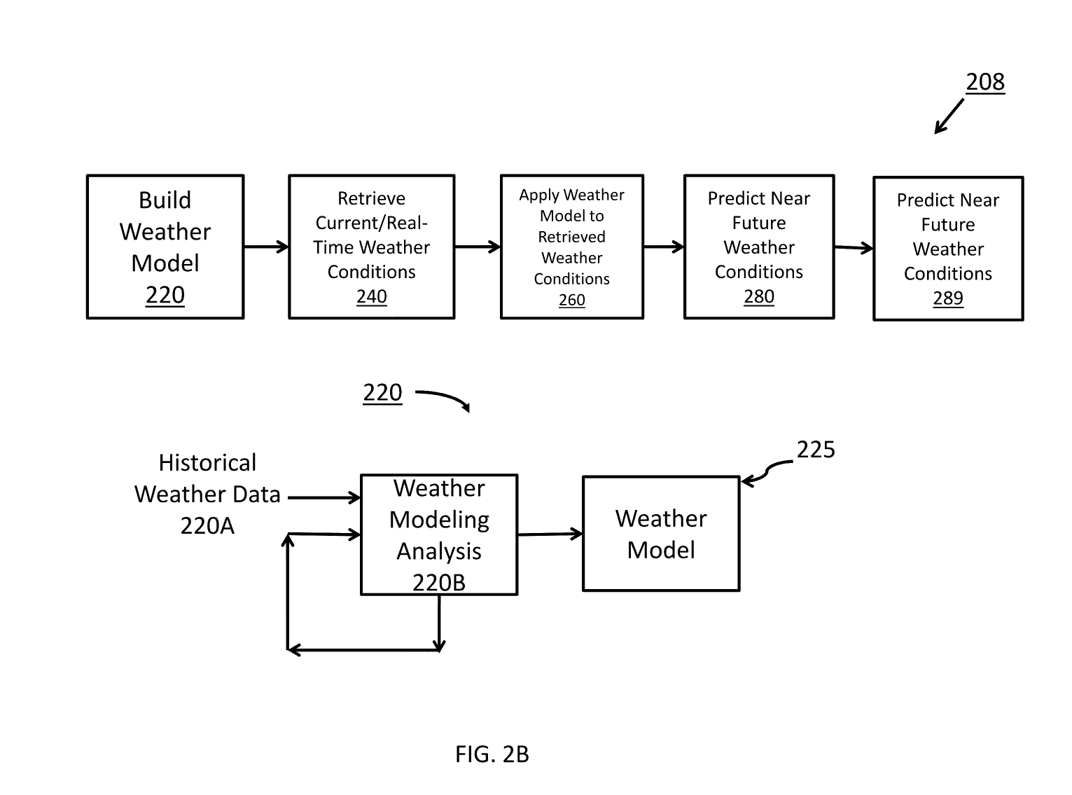

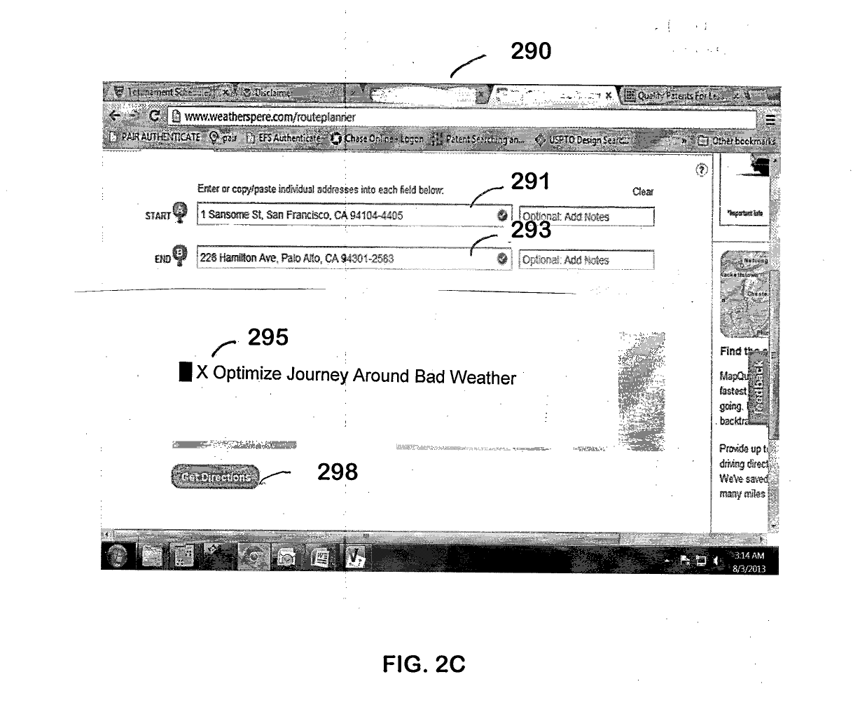

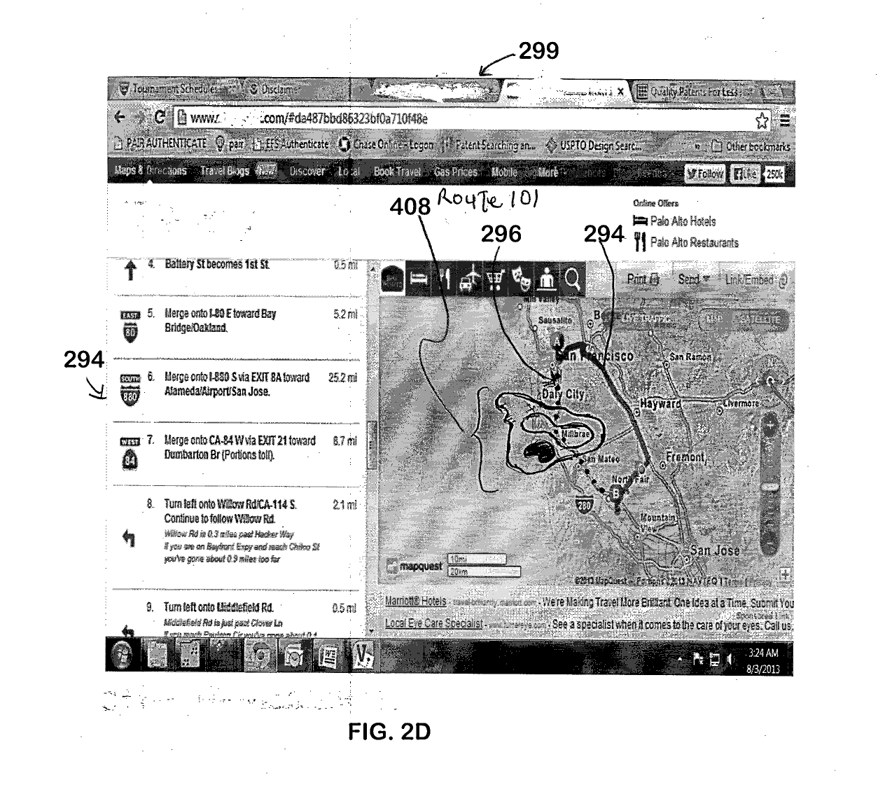

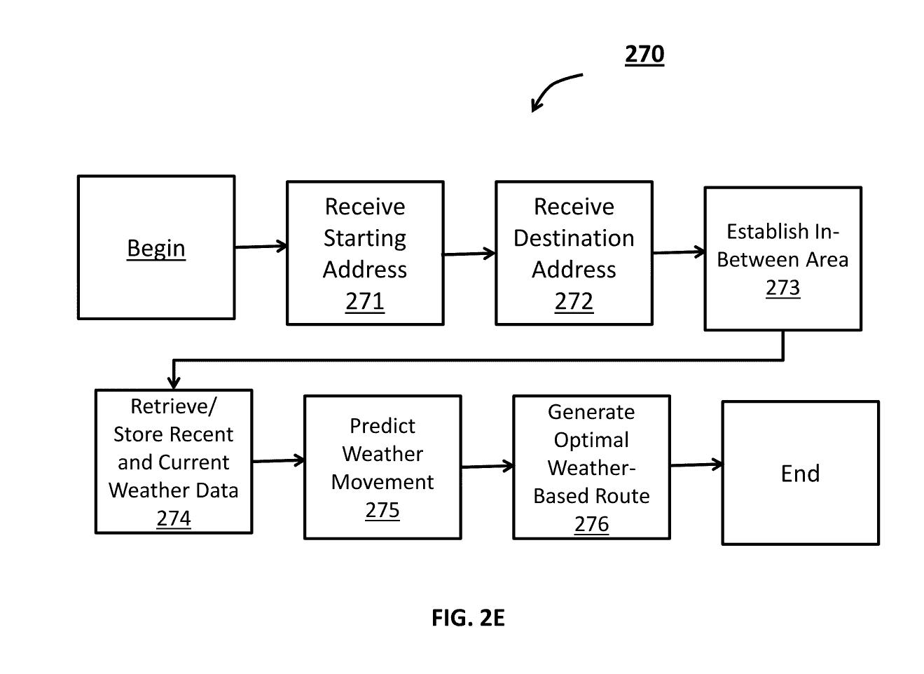

FIG. 2A illustrates the predictive server system 106 of FIG. 1 including a journey planning engine according to an exemplary embodiment of the present invention.

In FIG. 2A, predictive server system 106 includes web server 202 that receives weather forecasting data from weather data service 114, for example. Weather data can also be received from additional sources or in lieu of weather data service 114.

Here, weather data received by web server 202 is transferred to data collection module 204. Data collection module 204 might store the weather forecast data in a database 206, or it might be used on a real-time basis by forecasting algorithm 208. It will be appreciated that database 206 can be separate from or a part of a computing device employing data collection module 204 without departing from the scope of the present invention.

In FIG. 2A, predictive server system 106 also includes layering engine 214 that layers past, current and predicted weather data on a map generated by map module 210. Animation/sequencing engine 212 animates and sequences multiple frames of weather data superimposed on maps generated by map module 210. The layered maps are then provided to user via web server 216.

In FIG. 2A, predictive server system 106 further includes journey planning engine (weather based) 207 that utilizes predictive data from forecasting algorithm 208 to provide driving directions based upon such predicted weather data. Journey planning engine 207 provides accurate turn-by-turn routing that directs the user around bad weather segments so as to yield an optimal route for the user. Predictive server system 106 and weather application 105 are further operable as described with reference to the figures below.

FIG. 2B illustrates an exemplary forecasting algorithm 208 for use with the present invention, according to one embodiment.

In FIG. 2B, forecasting algorithm 208 involves initially building a weather model as shown at block 220. Specifically, a large amount of historical weather data 220A is fed through weather modeling analysis 220B that analyzes the historical weather data 220A to generate a weather model 225.

At block 240, after the weather model 225 is generated, the current or real-time weather data/conditions are retrieved from data collection module 204 for application to weather model 225. Specifically, at block 260, the weather model 225 is applied to the current or real-time weather conditions to predict near future weather conditions at block 280. At block 289, future weather conditions are used to provide optimal routing conditions for driving, air travel, etc., as further described below.

Note that historical weather data and current or real-time weather data can be high-resolution precipitation information, either via Doppler radar echo strength or satellite images. For example, consider real-time satellite images of clouds. The weather model 225, because of the historical data used to generate the model, can predict the motion, evolution, growth, reduction, expansion, or distortion of masses of gaseous or liquid fluids floating in another medium. If the system receives a few consecutive satellite images every predetermined period (30 seconds, 5-10 minutes, 20 minutes, 30 or 60 minutes, for example) of region having clouds, the forecasting algorithm 208 can determine the velocity and direction of movement of each cloud particle by examining the sequence of images.

In one implementation, the system grids velocity information at a high resolution for each point in the cloud region. By applying the same velocity to the most recent actual image, the near future location of the cloud particles can be determined by extrapolation, for example.

It will be appreciated that the above example does not take into account other factors that can impact the movement of clouds, such as wind speed for the region, humidity, time of day, terrain, etc. The forecasting algorithm 208 takes all factors into account where possible. Further, it will be appreciated that the above example addresses the movement of clouds, however the predicted motion of rain storms, lightning strikes, hurricanes and other similar weather type patterns can also be determined using the present algorithm and system.

In one implementation, for certain weather regions, the forecasting algorithm 208 uses historical cloud motion information about that region to build a velocity grid pattern as it actually happened over the last 20 years. With current or recent weather data added to the velocity grid, a composite grid pattern that is highly accurate is obtained.

As an example of a specific calculation, for each type of data, whether it is cloud or rain intensity or wind speed or terrain elevation, a two-dimensional grid of that data for the region is determined; application of the algorithm then calculates a grid of same size, that at each point stores the velocity and direction of the data at that point (called the flow vector).

So, given a cloud image, and a two-dimensional flow vector of the same size as that image, for each pixel in the cloud image, the corresponding pixel in the flow vector specifies how by many pixels to displace the original cloud pixel in X and Y direction. By applying this calculation to each pixel in the original cloud image, we get a resulting cloud image in which each pixel's value came from some other location in the original image.

FIG. 2C illustrates a screen shot of driving directions interface 290 of weather application 105 according to an exemplary embodiment of the present invention.

In FIG. 2C, user 102 can utilize mobile computing device 104 and weather application 105 to obtain optimal routing directions such as driving directions from journey planning engine 207 of predictive server system 106 based on predicted near future weather.

In one embodiment, journey planning engine 207 receives and generates requisite data via driving directions interface 290, for example. As seen, driving directions interface 290 includes a start field 291 in which user 102 can enter a beginning address from which driving is to start. Driving directions interface 290 further includes an end address 293 that receives the ultimate destination of the user.

As can be seen here, user 102 has entered “1 Sansome Street, San Francisco as the beginning address and has also entered 228 Hamilton Avenue, Palo Alto, Calif., as the ending address. User 102 has also selected checkbox 295 directing journey planning engine 207 and weather application 105 to optimize the journey around bad weather. Thereafter, user 102 simply selects the “get directions” button 298 to obtain navigation directions as discussed with reference to FIG. 2D.

An advantage of the present invention is that using button 295 “Optimize Journey Around Bad Weather,” the present invention analyzes the best and optimal route based on predicted near future weather information from the beginning location to the destination location. Weather or precipitation information can include rain, snow, hail, tornadoes, hurricanes, fire, floods and other types of conditions that affect travel. The effect of each specific type of weather or precipitation is accounted for separately and appropriately.

For example, heavy snow will have a different effect on navigation/driving compared to heavy rain. Where heavy snow is predicted, the system is weighted to completely route around the region with heavy snow. Where heavy rain is predicted, the system may consider routing through areas of heavy rain depending on available alternate routes.

Navigation includes all types of transportation or travel, including driving, walking, bicycle, powered or unpowered, flying, sea travel, water transportation etc. Furthermore, in some embodiments, during a trip, the system can continuously update, refine/redirect the rest of the trip based upon changes/updates in weather prediction information.

FIG. 2D illustrates driving directions interface 299 showing navigation directions from “1 Sansome Street, San Francisco, Calif.” to “228 Hamilton Avenue in Palo Alto, Calif.”.

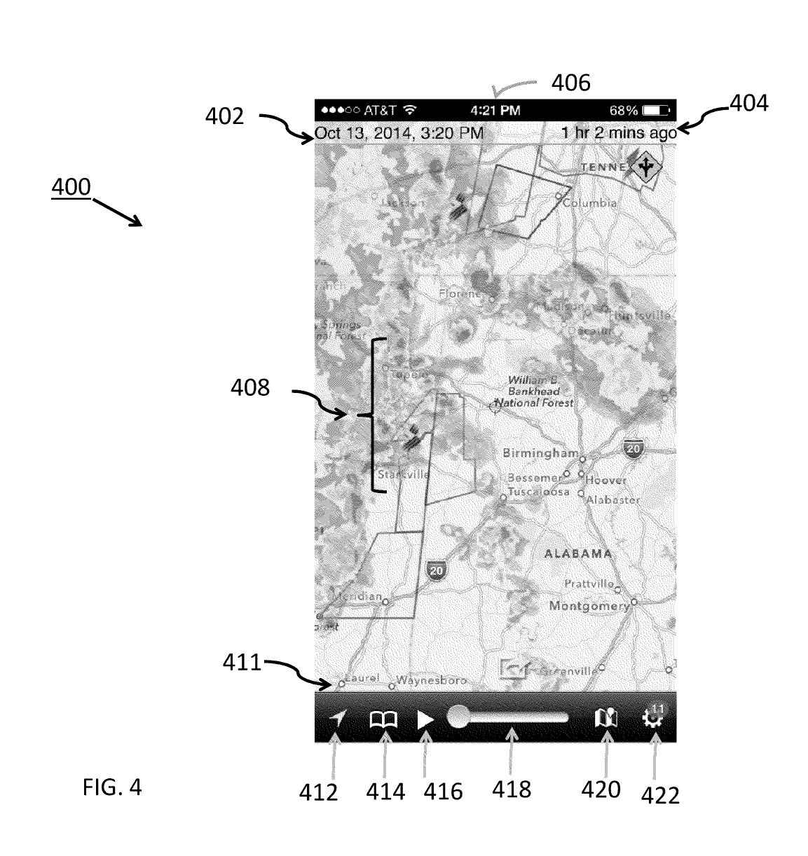

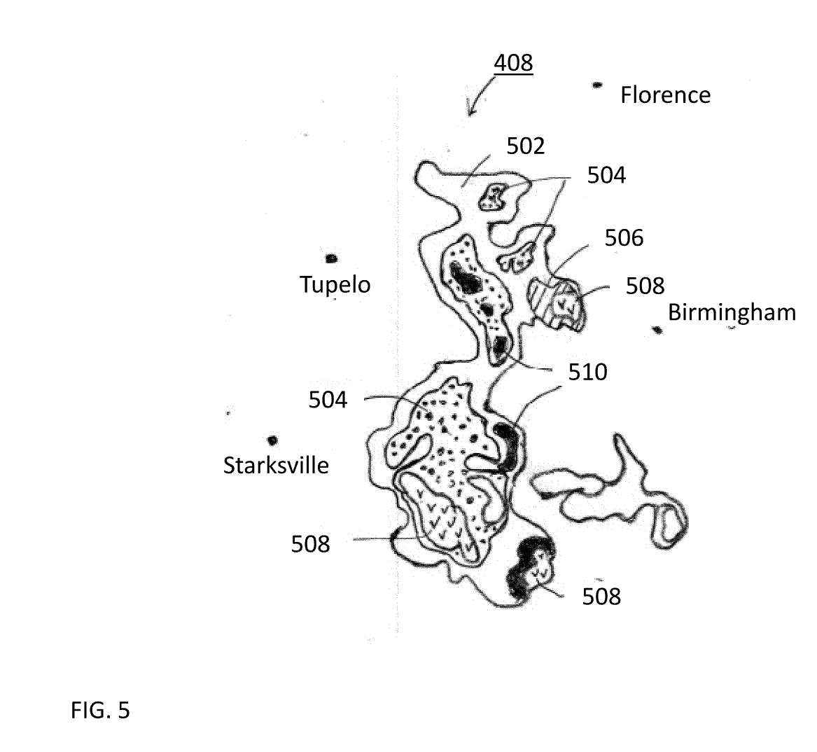

In FIG. 2D, weather application 105 has provided driving directions based on severe weather conditions. Here, forecasting algorithm 208 of FIG. 2A has forecasted weather data that is used to generate the contour map 408, which indicates geographical locations of severe weather as further discussed with reference to FIG. 4 and FIG. 5.

Journey planning engine 207 receives the forecasted weather data from forecasting algorithm 208 and uses that to generate optimal driving directions that navigate around the contour map 408. As is well known by those familiar with this route, and as can be seen here, the most direct route from San Francisco to Palo Alto is via Route 101 through Daly City and Milbrae indicated as broken line 296 on the map.

However, because of contour map 408 showing severe weather around Milbrae and Daly City, journey planning engine 207 has provided alternate directions 294 from San Francisco to Palo Alto around contour map 408. In this manner, the present invention uses weather considerations to provide optimal directions to users, thus saving lives, property and other catastrophic damage caused by inclement weather conditions.

Here, it should be noted that for the present invention, accurate weather/precipitation information is be available at street level resolution to make turn by turn decisions. Furthermore, it should be noted that merely current/recent weather information is not sufficient. Since a trip could be several hours long, and weather can change during that time, the system of the present invention uses predicted weather information at temporally corresponding segments of the trip to perform accurate routing.

For example, for a trip approximately 1 hour long, near the start of the trip the current/latest weather/precipitation information is used. Near the middle of the trip, weather information predicted one-half hour into the future, for that geographic region, is used; and near the end of the trip, forecasted information an hour into the future is used for the designation's geographic region must be used.

FIG. 2E illustrates weather-based navigation method 270 according to an exemplary embodiment of the present invention.

In FIG. 2E, user 102 can utilize navigation method 270 for plotting a route and generating directions for travelling from a beginning location to a final destination. Routing may be for driving directions from a first to a second destination, for example. As another example, routing may be for air travel from one city to another, where navigation method 270 provides directions in real-time to avoid hazardous weather conditions as an airplane proceeds to arrival from a departure city.

Navigation method 270 employs mobile computing device 104, on which weather application 105 is executed, in communication with predictive server system 106 and weather data service 114. As shown in FIG. 1, predictive server system 106, itself, includes journey planning engine 207 that generates optimal routing directions based on predicted near future weather.

At block 271, assuming user 102 wishes to utilize navigation method 270 for driving directions, user 102 initiates weather application 105 on mobile computing device 104 and then enters a starting location address. Alternatively, a map might be displayed on which user 102 can select a starting location.

At block 272, navigation method 270 receives on mobile computing device 104, a destination location on a map or receives the destination address for the trip.

At block 273, the area directly between the starting location and the destination location is established. This in-between area includes the most direct route between the starting and ending destination. The distance across this in-between area can be set by default or may be selected by user 102. For example, user 102 may set the width of this in-between area as no more than five miles.

In essence, user 102 is indicating that irrespective of weather conditions, user 102 does not wish to be routed outside of this area. Note that the in-between area is also one that includes transportation routes that are usable for the trip from the starting location to the destination location. If there are no suitable transportation routes, the in-between area is extended until a suitable transportation route is found.

At block 274, navigation method 270 uses the starting and destination location and the in-between area to collect and store, in memory, recent and current weather for respective areas. Specifically, predictive server system 106 uses the starting and destination and in-between area information to locate recent weather data in data collection module 204 (FIG. 2A).

Here, recent weather data is real-time weather data including weather data from up to 60 minutes prior to the specific start time of the trip. In this manner, predicted output data is substantially real time. In one embodiment, the time interval (e.g. 60 minutes) for the recent weather data is predetermined ahead of time (and not on the fly). That is, the time interval is set by the system by default or may be set by user 102 in weather application 105.

Note here that although the area for which the recent data is retrieved is determined by address locations, and the area therein-between, one skilled in art will realize that other methods for determining such areas can be utilized. For example, the present invention may utilize zip codes of starting, destination and associated trip areas to retrieve recent weather data for those areas.

At block 275, navigation method 270 involves predicting weather movement for the starting location, the in-between area and the destination location based in part on the recent and current weather data for the starting location. Here, weather movement for the starting location may be optional, in another embodiment, as user 102 might be located at the starting location, proceeding with the trip and in all likelihood will have left the starting location before any appreciable change in weather movement occurs.

Weather movement prediction may use a few consecutive satellite images every 5-10 minutes, for example. If so, forecasting algorithm 208 can determine the velocity and direction of movement of each cloud particle by examining the sequence of images. In one embodiment, the system grids velocity information at a high resolution for each point in the cloud region. By applying the same velocity to the most recent actual image, the near future location of the cloud particles for the next sixty minutes or so can be determined by extrapolation, for example.

In short, to determine expected weather movement, recent weather data can be segregated into a periodic sequence of weather data, e.g., periods of five, 10 or 15 minutes), where the periodic sequence is extrapolated into the future for typically about 60 minutes from the current time. The extrapolated sequence is then applied to the most recent location of weather to yield an expected weather movement.

As discussed with reference to FIG. 2B, the method of the present invention may also employ weather model 225 (FIG. 2B), which includes a large amount of historical weather data 220A. When weather model 225 is applied to current or real-time weather data, expected weather movement for the near future is obtained.

At block 276, navigation method 270 involves uses journey planning engine 207 to generate an optimal route from the starting location through or around the in-between area to the destination location based in part on the expected movement of weather for the respective locations. In one embodiment, journey planning engine 270 includes a representation of available routes, schedules and network times for various transportation types including roads, trains, airlines, etc.

Journey engine 207 may rapidly compute, in conjunction with expected weather movement from forecasting algorithm 208, an optimal path from a starting to a destination location. The optimal path can be based on a number of factors including whether the predicted weather is extreme, the distance to the destination, the available routes and expected time of travel, for example.

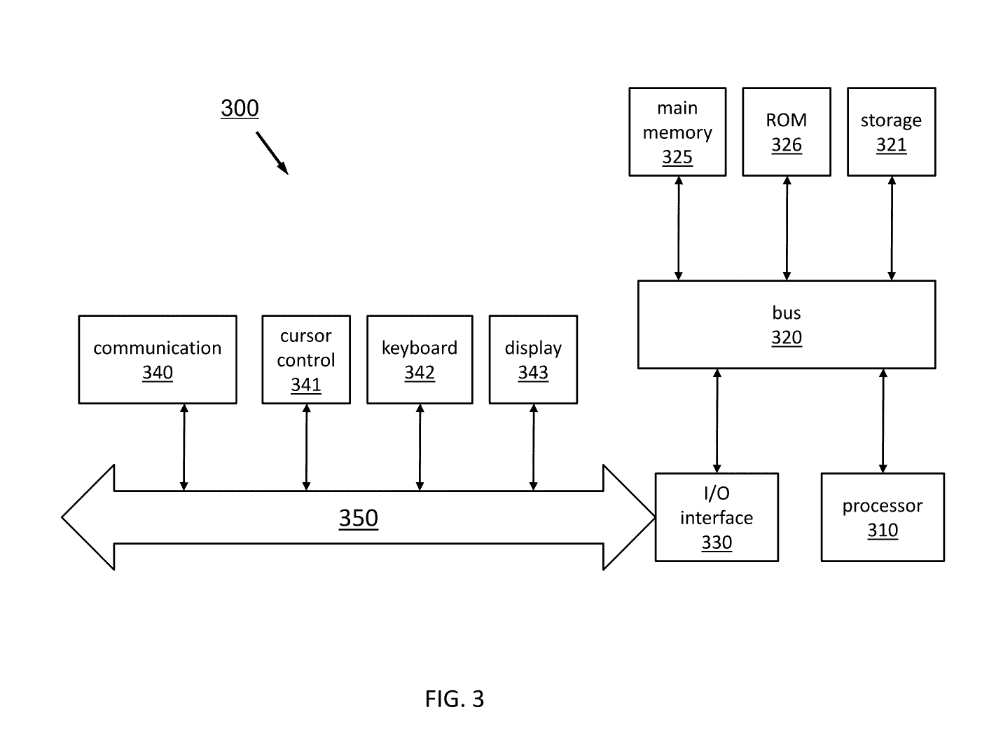

FIG. 3 illustrates an exemplary computer architecture for use with an exemplary embodiment of the present invention.

One embodiment of architecture 300 comprises a system bus 320 for communicating information, and a processor 310 coupled to bus 320 for processing information. Architecture 300 further comprises a random access memory (RAM) or other dynamic storage device 325 (referred to herein as main memory), coupled to bus 320 for storing information and instructions to be executed by processor 310. Main memory 325 also may be used for storing temporary variables or other intermediate information during execution of instructions by processor 310. Architecture 300 may also include a read only memory (ROM) and/or other static storage device 326 coupled to bus 320 for storing static information and instructions used by processor 310.

A data storage device 325 such as a magnetic disk or optical disc and its corresponding drive may also be coupled to architecture 300 for storing information and instructions. Architecture 300 can also be coupled to a second I/O bus 350 via an I/O interface 330. A plurality of I/O devices may be coupled to I/O bus 350, including a display device 343, an input device (e.g., an alphanumeric input device 342 and/or a cursor control device 341).

The communication device 340 allows for access to other computers (e.g., servers or clients) via a network. The communication device 340 may comprise one or more modems, network interface cards, wireless network interfaces or other interface devices, such as those used for coupling to Ethernet, token ring, or other types of networks.

FIG. 4 illustrates a display of map 400 on a mobile computing device in accordance with an exemplary embodiment of the present invention. It will be appreciated that, while the illustrative displays presented herein are taken from a mobile computing device, the present disclosure is in no way limited to implementation on a mobile computing device.

In FIG. 4, user 102 (FIG. 1) has downloaded weather application 105 (FIG. 1) to a mobile computing device 104 and has launched weather application 105 to generate map 400 as shown. Contour map 408 is also shown superimposed on map 400. Contour map 408 shows the geographical location of present, past or future event on map 400. Contour map 408 is further illustrated with reference to FIG. 5.

Another advantage of the present invention is that weather application 105 generates control interface 411 for manipulating movement of map 400 and selecting various options for adapting the map to the user's preference.

Control interface 411 includes location button 412 and pin button 414. Location button 412 is for location-based services and identifies the location of the device 104 on map 400 and provides associated past weather information and future weather information for that specific location. Pin button 414 permits user 102 to pin locations on map 400 so that weather information associated with the pinned location can be provided. Icon 414 also enables user 102 to use an address to identify a location.

Control interface 411 includes play button 416, forward/rewind button 418 and preferences button 420. As can be seen, play button 416 plays map frames with current and predicted weather data. Forward/rewind button 418 permits user 102 to forward or replay map frames. Preferences 420, among other functionalities, allow users to choose weather data layers that are superimposed on map 400.

User 102 can also employ weather application 105 on a computing device to instantaneously display a sequence of maps having historical and future weather data. As an example, contour map 408 is generated based on weather data that occurred 1 hour and 2 minutes ago, designated 404. The weather data was generated on Oct. 13, 2014, at 3:20 p.m. as shown at 402. As shown at 406, the current time is 4:21 p.m. Thus, weather application 105, in conjunction with predictive server system 106 has generated a frame with map 400 based on weather data that occurred sixty-two (62) minutes ago.

FIG. 5 illustrates contour map 408 according to an exemplary embodiment of the present invention.

In FIG. 5, contour map 408 defines the boundaries of weather events that occur according to the geographical location of such weather events. Contour map 408 shows that there has been weather activity between Tupelo, Starksville, Birmingham and Florence. Contour map 408 shows area 502 that represents light rain activity, area 404 that represents moderate rain activity and area 506 that represents moderate to severe rain activity.

Contour map 408 also shows area 508 that represents increasing rain activity and area 510 that represents very severe rain activity with severe thunderstorms. One skilled in the art will appreciate that different colors may be utilized to represent the shaded areas to indicate weather activity.

Other areas on the map can also represent snow activity from light snow to heavy snowfall. Contour map 408 can also represent minor flood advisories, moderate flood warnings, severe thunderstorms or extreme tornado warnings. In this exemplary embodiment, contour map 408 is based on weather data received from weather data service 114. In this manner, users can utilize contour map 408, which is displayed in high definition, to quickly determine areas on map 400 that have or might have severe weather.

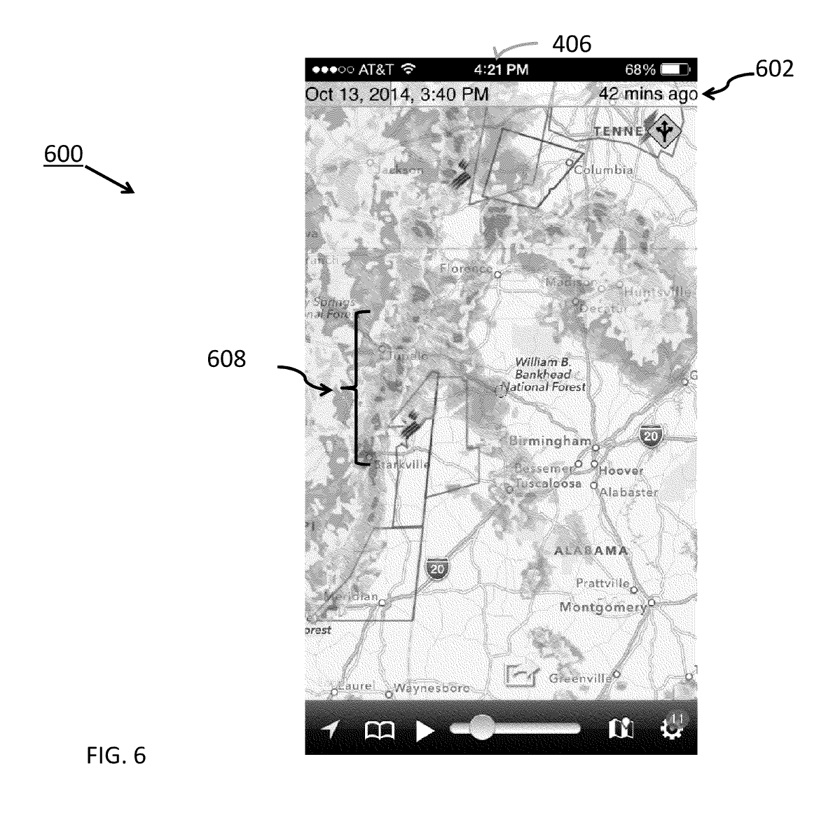

In FIG. 6, weather application 105 has generated another frame, map 600. Map 600 uses contour map 608 and weather data obtained forty-two (42) minutes ago as shown at 602. In this manner, animation/sequencing engine 212 (FIG. 2) can play the frames for map 400 (FIG. 4) and map 600 (FIG. 6) back to back.

As can be seen, map 400 and map 600 are played sequentially back to back at 4:21 PM, designated 406. Contour map 608, which evolved from contour map 408 of FIG. 4, shows that weather activity over Route 78 has dispersed although some activity appears to have moved closer to Tupelo.

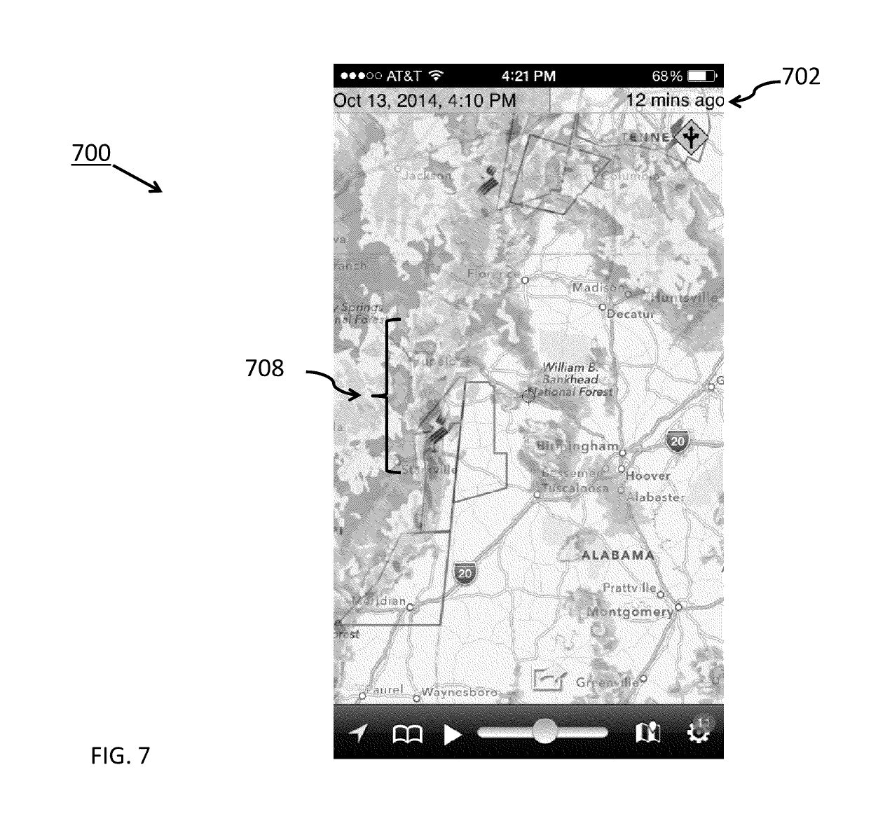

In the next sequence, as shown in FIG. 7, map 700 shows contour map 708 based on weather data obtained twelve (12) minutes ago, designated 702. Contour map 708 in FIG. 7 shows that weather activity has moved closer to Tupelo but away from Starksville.

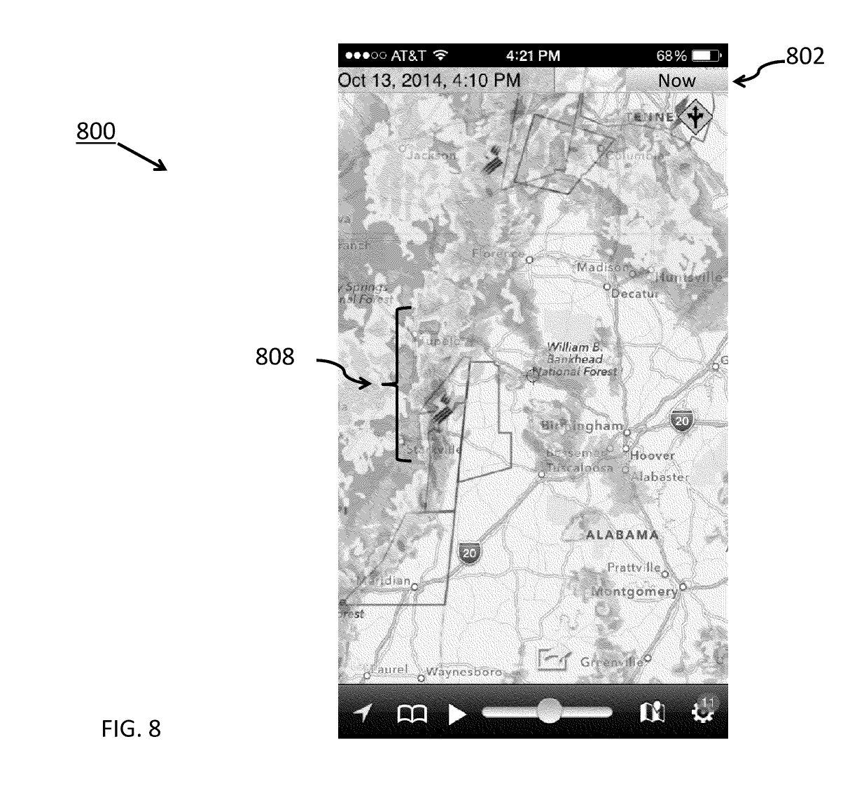

In the next sequence, in FIG. 8, contour map 808 is based on the present weather data as shown at 802. Contour map 808 shows that Tupelo is witnessing some weather activity now; there is some activity on Route 78 and no weather activity in Starksville.

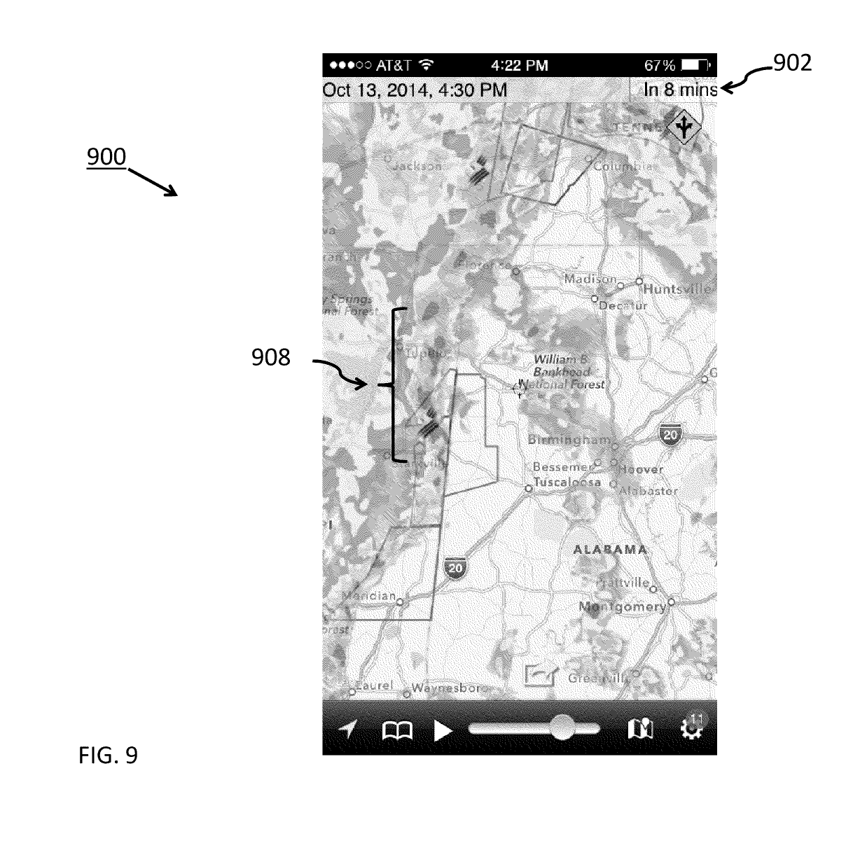

In the next sequence, in FIG. 9, another advantage of the present invention becomes apparent as contour map 908 is based on weather data extrapolated by predictive server system 106. Specifically, contour map 908 in map 900 is based on weather data that is predicted to occur in eight (8) minutes, designated as 902.

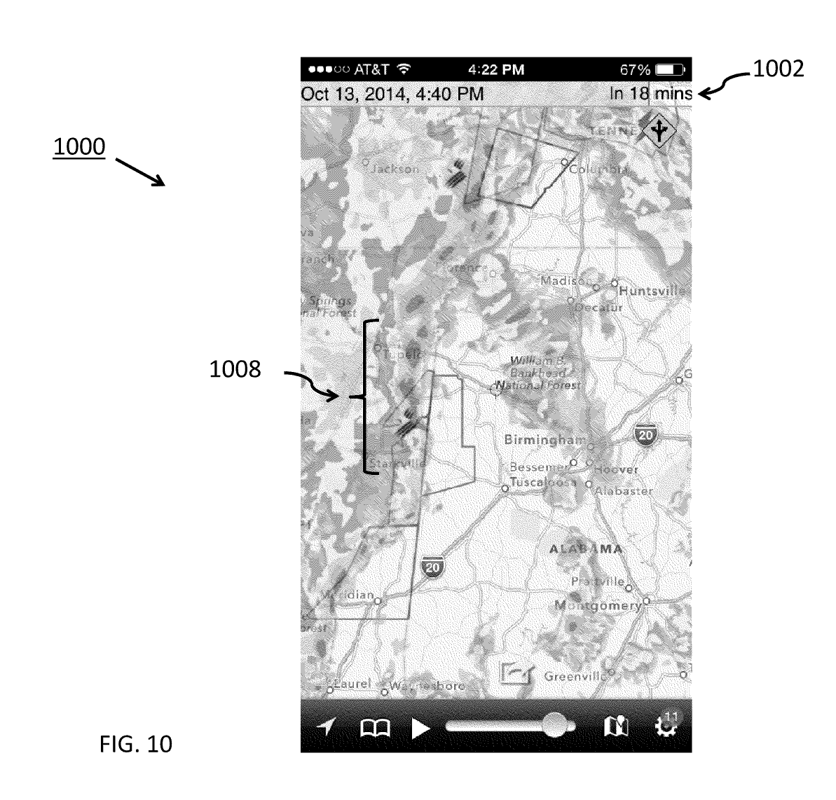

Here, it is predicted that Tupelo will continue to have weather activity in eight (8) minutes. In FIG. 10, contour map 1008 in map 1000 is based on weather data predicted to occur in eighteen (18) minutes, designated 1002. Here, it is predicted that in eighteen (18) minutes, Tupelo will no longer witness weather activity while Route 78 will see increased weather activity.

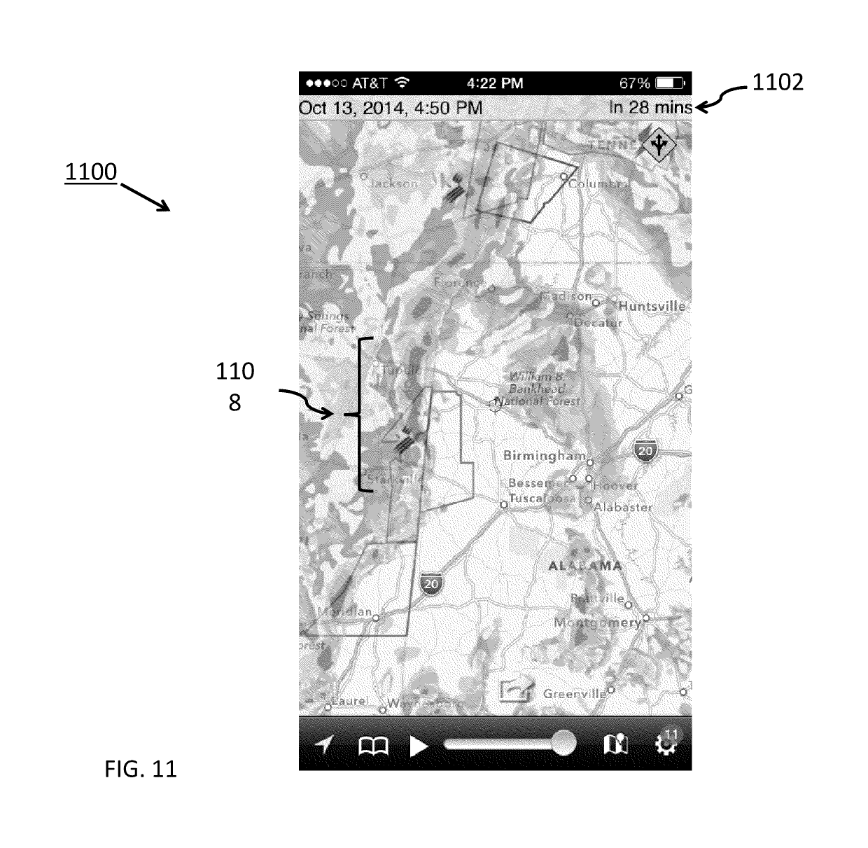

Next in the sequence, in FIG. 11, sequence map 1108 in map 1100 is based on weather data predicted to occur in twenty-eight (28) minutes as shown at 1102. Here, Tupelo will witness no weather activity while Route 78 will continue to see weather activity.

Thus, as can then be seen, user 102 can utilize weather application 105 on a computing device to generate, in one embodiment, weather maps superimposed with past and future weather data. Past weather data for at least over sixty (60) minutes ago can be generated.

Future weather data for at least over sixty (60) minutes can be extrapolated. Superimposition of past weather data is not limited to sixty (60) minutes but the duration may be longer or shorter. Similarly, extrapolation of future data is not limited to sixty (60) minutes, but may be longer or shorter as well.

All of the frames for the weather data are generated dynamically and played in sequence, one after the other. User 102 can moreover select the speed at which the weather map frames are played. Most importantly, real-time or current weather data can be data within the last one, two, five minutes or within seconds.

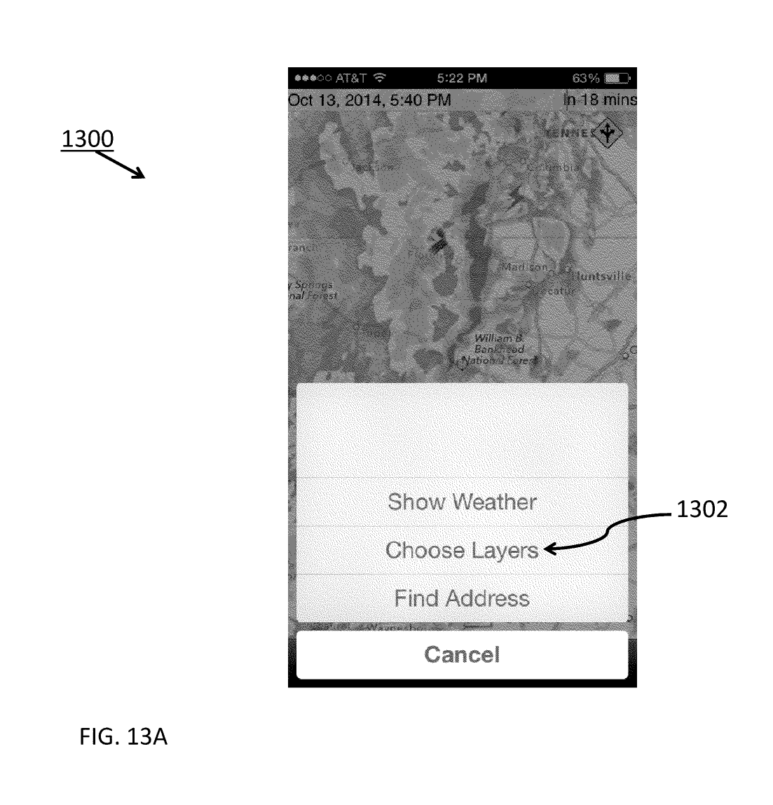

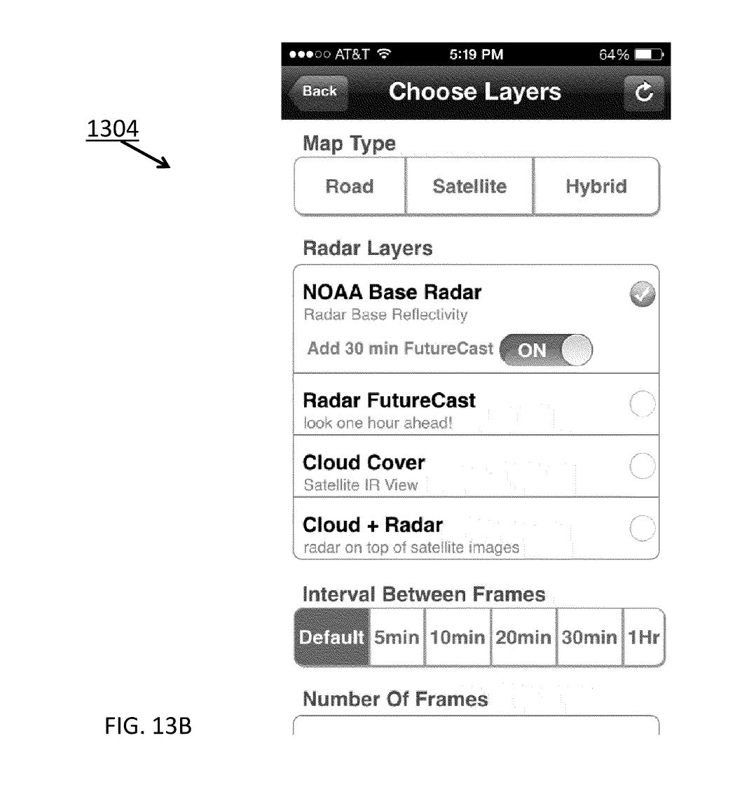

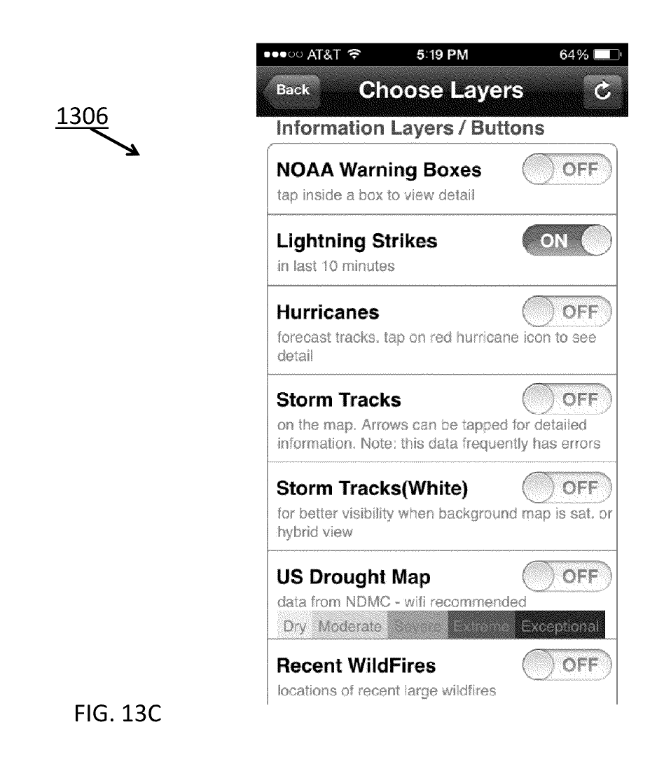

FIGS. 13A-13C illustrate exemplary user customizations for use with the present invention, according to one embodiment.

As shown in FIG. 13A, a weather application 105 presents an interface 1300 through which a user 102 can advantageously choose different layers 1302 of weather data that can be superimposed on map 400.

For example, user 102 may choose to impose hurricane data, that is, locations where hurricanes have occurred and where hurricanes are predicted to occur in the future. Layers can include one or more of lightning strikes, hurricanes, drought, wildfires, storms, temperature, humidity, or precipitation.

As shown in FIG. 13B, user 102 selects display options from an interface 1304. FIG. 13B shows that a user may select a map type, from one or road, satellite, or hybrid. FIG. 13B further shows that a user may select the interval between frames, and the interval in this example can be one of 5 minutes, 10 minutes, 20 minutes, 30 minutes, or 60 minutes.

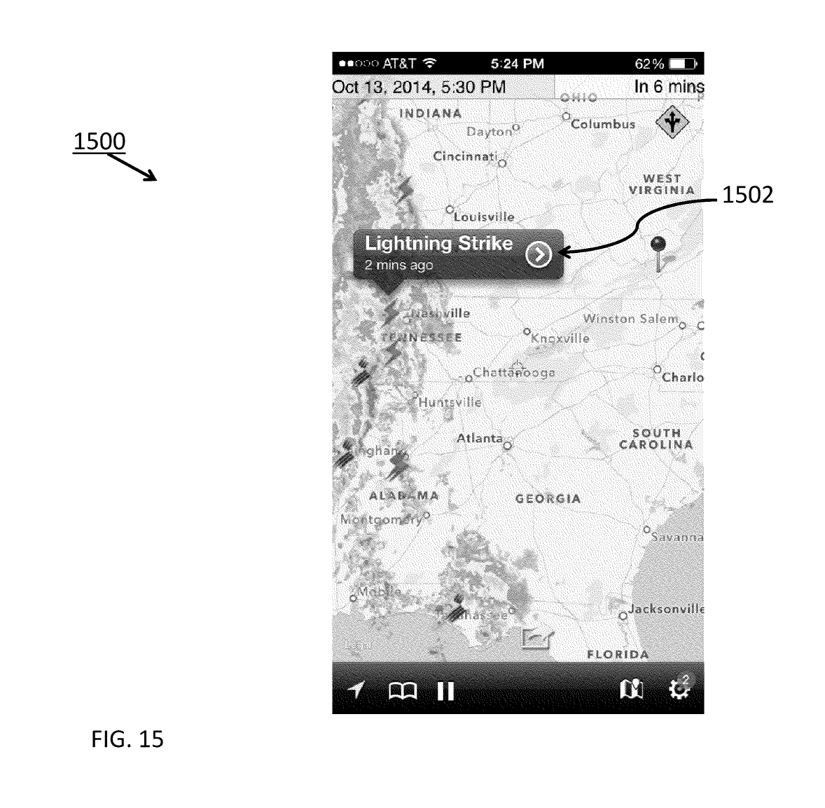

FIG. 13C further illustrates an interface 1306 through which user 102 may select layers. User 102 can choose to show predictive weather data, storm tracks, hurricanes, a drought map, recent wildfires, or may choose to show lightning strikes as shown with reference to FIG. 15, which is a map 1500 that illustrates lightning strikes indicated by 1502, for example.

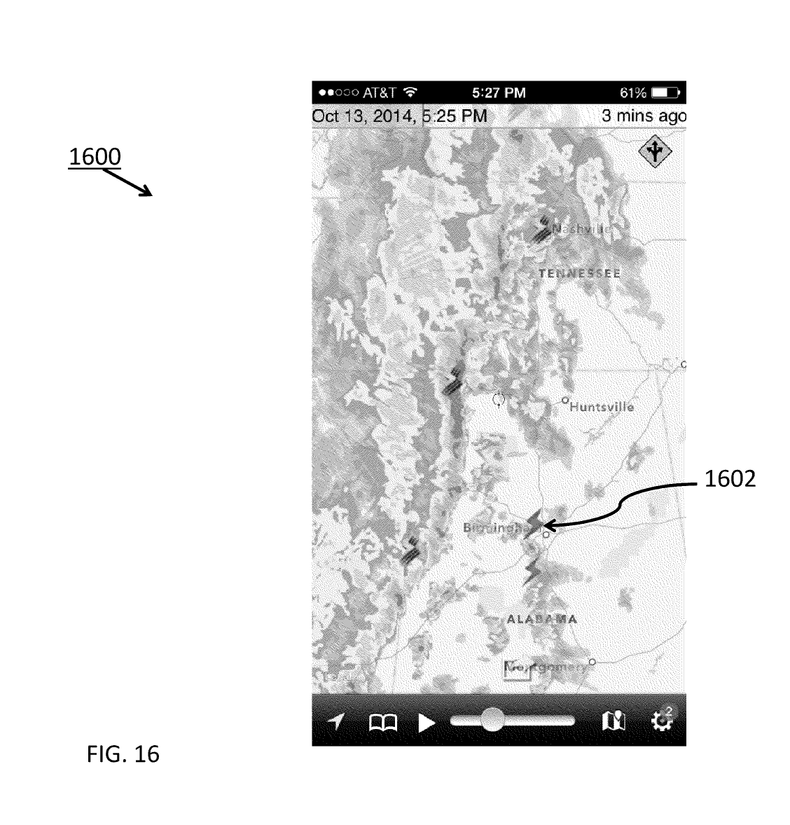

FIG. 16 also illustrates a map 1600 with an indication of a lightning strike 1602. User 102 can also show cloud cover, select intervals between frames, radar Doppler sites, Signets and travel/on-the-road weather data.

As discussed above with regard to FIG. 2B, weather application 105 uses actual real time precipitation data collected on the last few hours, uses historical trends of storms from the last few years, uses wind direction, uses elevation information and uses pressure gradient information to predict the motion of rain storms, clouds and other similar weather patterns. Although not shown, weather application 105 can use any and all types of weather data; weather data that can be used is not limited to the aforementioned weather data types.

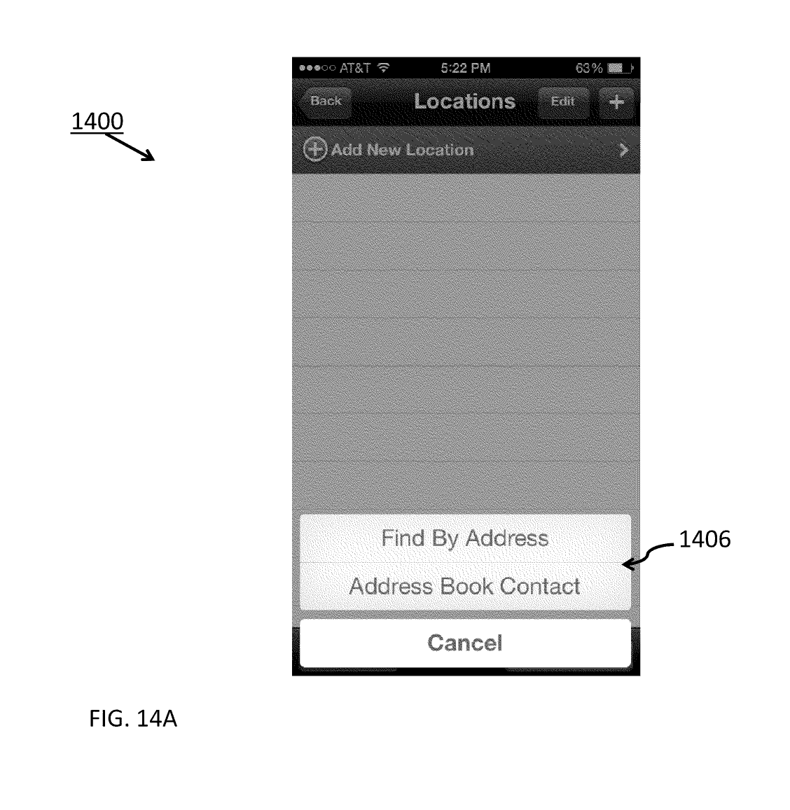

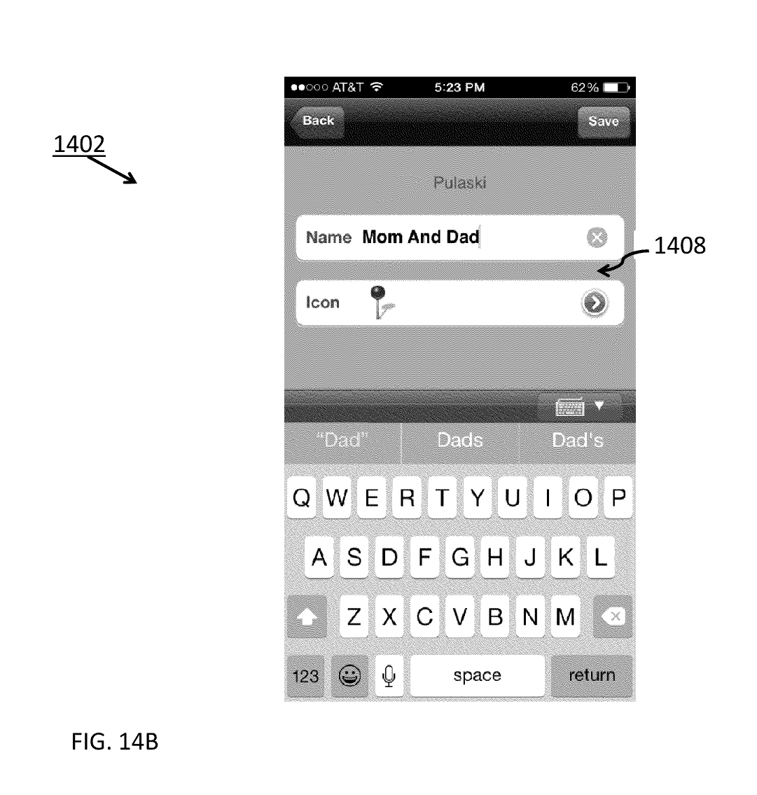

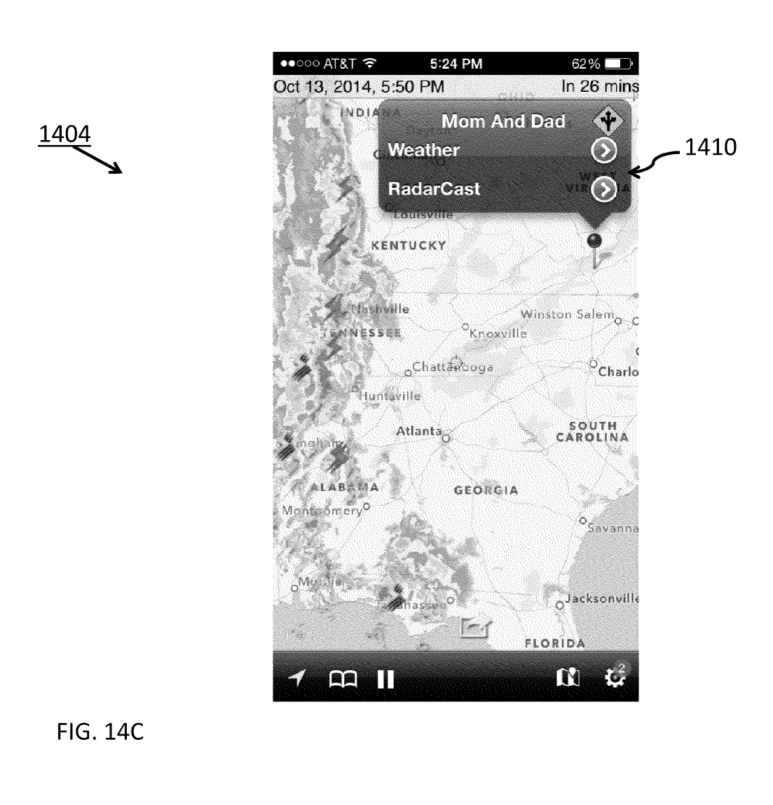

In FIGS. 14A-C, it is shown that weather application 105 enables user 102 to select any desired location on the underlying map. Interface 1400 provides selection 1406 of a location by address or by looking up in the address book of the computing device. Interface 1402 illustrates a user's ability to define locations of loved ones, Mom and Dad, 1408.

Interface 1404 illustrates weather application 105 displaying the location 1410 of Mom and Dad on the map, as well as available options for viewing the weather where Mom and Dad are and predictive weather associated with their location.

As mentioned above, FIGS. 15-16 illustrate maps 1500 and 1600 having indications of lightning strikes 1502 and 1602, respectively.

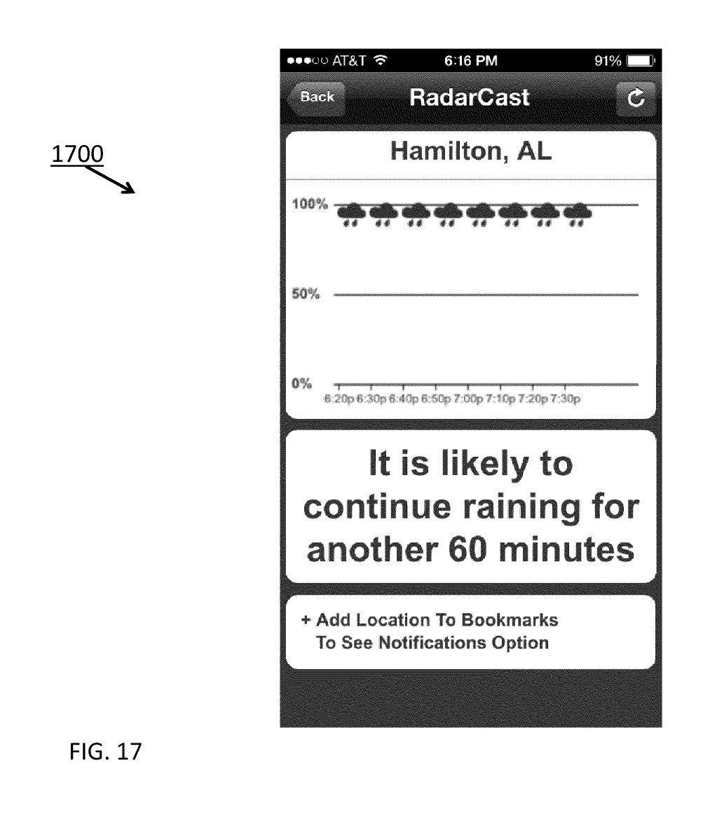

FIG. 17 illustrates an exemplary interface 1700 displaying predictive weather associated with a location.

While the above is a complete description of exemplary specific embodiments of the invention, additional embodiments are also possible. Thus, the above description should not be taken as limiting the scope of the invention, which is defined by the appended claims along with their full scope of equivalents.

We claim:

1. A weather-based method for navigating from one location to another, the method employing a mobile computing device in communication with a server having a processor via a network, the mobile computing device comprising a computer readable memory having a processor, the method comprising:
by the one or more processors, receiving on the mobile computing device, a starting location on a map or an address of the starting location for a trip;
by the one or more processors, using the starting location to collect and store, in memory, recent and current weather data for the starting location, wherein the recent weather data includes data for a recent time interval prior to a starting time of the trip, wherein said past time interval is predetermined;
by the one or more processors, receiving on the mobile device, a destination location on a map or an address of the destination location for the trip;
by the one or more processors, using the destination location to collect and store, in memory, recent and current weather data for the destination location, wherein the recent weather data is for a recent time interval prior to the starting time of the trip to ensure future output data is substantially real time, wherein said recent time interval for the destination location is predetermined;
by the one or more processors, determining an in-between area that extends directly between the starting location and the destination location but only if said in-between area includes transportation routes that are usable for the trip from the starting location to the destination location;
by the one or more processors, using the in-between area to collect and store, in memory, recent and current weather data for the in-between area, wherein the recent weather data is for a recent time interval prior to the starting time of the trip; wherein said recent time interval for the in-between area is predetermined;
by the one or more processors, determining an expected movement of weather for the starting location based in part on the recent and current weather data for the starting location;
by the one or more processors, determining an expected movement of weather for the in-between area based in part on the recent and current weather data for the in-between area;
by the one or more processors, determining an expected movement of weather for the destination location based in part on the recent and current weather for the destination location; and
by the one or more processors, determining an optimal route from the starting location through or around the in-between area to the destination location based in part on the expected movement of weather for the starting location, the in-between area and the destination location.

2. The method claim 1 wherein determining an optimal route is
by the one or more processors, determining a severity of the expected weather movement; and
by the one or more processors, if the expected weather movement is severe, generating travel directions that route the trip around the expected weather movement.

3. The method of claim 1 wherein said determining an expected weather movement for each of the starting location, destination location and in-between area is
by the one or more processors, using the predetermined and recent time intervals of recent weather data to create a periodic sequence of weather data (e.g., periods of five minutes);
by the one or more processors, and in real time, extrapolating the periodic sequence of weather data into the future for a future time interval extending generally 60 minutes into the future from a current time; and
by the one or more processors, applying the extrapolated sequence to the most recent location of weather to yield an expected weather movement.

4. The method of claim 1 wherein said determining an expected weather movement for each of the starting location, destination location and in-between area is
by the one or more processors, applying a weather model to the recent weather data to obtain the expected weather movement.

5. The method of claim 1 further comprising
by the one or more processors, after initiation of the trip, re-determining an optimal route at temporal segments of the trip.

6. A computer program product including a computer readable storage medium and including computer executable code which when executed by a processor is adapted to:
receive a mobile computing device, a starting location on a map or an address of a starting location for a trip;
use the starting location to collect and store, in memory, recent and current weather data for the starting location, wherein the recent weather data includes data for a recent time interval prior to a starting time of the trip, wherein said past time interval is predetermined;
receive on the mobile device, a destination location on a map or an address of the destination location for the trip;
use the destination location to collect and store, in memory, recent and current weather data for the destination location, wherein the recent weather data is for a recent time interval prior to the starting time of the trip to ensure future output data is substantially real time, wherein said recent time interval for the destination location is predetermined;
determine an in-between area that extends directly between the starting location and the destination location but only if said in-between area includes transportation routes that are usable for the trip from the starting location to the destination location;
use the in-between area to collect and store, in memory, recent and current weather data for the in-between area, wherein the recent weather data is for a recent time time interval from the starting time of the trip; wherein said recent time interval for the in-between area is predetermined;
determine an expected movement of weather for the starting location based in part on the recent and current weather data for the starting location;
determine an expected movement of weather for the in-between area based in part on the recent and current weather data for the in-between area;
determine an expected movement of weather for the destination location based in part on the recent and current weather for the destination location; and
determine an optimal route from the starting location through or around the in-between area to the destination location based in part on the expected movement of weather for the starting location, the in-between area and the destination location.

7. The computer program product of claim 6 wherein determining an optimal route is by
determining a severity of the expected weather movement; and
if the expected weather movement is severe, generating travel directions that route the trip around the expected weather movement.

8. The computer program product of claim 6 wherein said determining an expected weather movement for each of the starting location, destination location and in-between area is by
using the predetermined and recent time intervals of recent weather data to create a periodic sequence of weather data (e.g., periods of five minutes);
and in real time, extrapolating the periodic sequence of weather data into the future for a future time interval extending generally 60 minutes into the future from a current time; and
applying the extrapolated sequence to the most recent location of weather to yield an expected weather movement.

9. The computer program product of claim 6 wherein said determining an expected weather movement for each of the starting location, destination location and in-between area is by
applying a weather model to the recent weather data to obtain the expected weather movement.

10. The computer program product of claim 6 further comprising
after initiation of the trip, re-determining an optimal route at temporal segments of the trip.
